(19) United States
(12) Patent Application Publication
(10) Pub. No.: US 2012/0072845 A1
(43) Pub. Date: Mar. 22, 2012

(54) SYSTEM AND METHOD FOR CLASSIFYING LIVE MEDIA TAGS INTO TYPES

(75) Inventors: Ajita JOHN, Holmdel, NJ (US); Shreeharsh Kelkar, Summit, NJ (US); Doree Duncan Seligmann, New York, NY (US)

(73) Assignee: Avaya Inc., Basking Ridge, NJ (US)

(21) Appl. No.: 12/887,248

(22) Filed: Sep. 21, 2010

(51) Int. Cl. G06F 17/30; G06F 15/16; G06F 3/048

(52) U.S. Cl. 715/738; 707/737; 707/E17.046

(57) ABSTRACT

Disclosed herein are systems, methods, and non-transitory computer-readable storage media for classifying a live media tag into a type. A system configured to practice the method receives a group of tags generated in real time and associated with at least a portion of a live media event, identifies a tag type for at least one tag in the group of tags, and classifies the at least one tag as the tag type. Tag types can include system-defined types, user-entered types, categories, media categories, and text labels. More than one user can generate tags for the media event via more than one tagging platform. The system can further identify the tag type by sending to a user a list of suggested tag types, receiving from the user a selection of a suggested tag type from the list, and identifying the tag type as the suggested tag type.

### BACKGROUND

1. Technical Field

The present disclosure relates to tags and more specifically to classifying tags into types.

2. Introduction

Users and media events are becoming more connected to the Internet and other networks. At the same time, users are able to provide tags of a media event while participating in the media event. For example, a viewer of a television show can tag a joke in the show as “funny”. Further, automatic taggers can generate tags of media events. The proliferation of tags from human and automated sources provides a potential wealth of information. However, that information is not easily accessible and is not typically in a uniform representation.

Further, the real-time aspect of user tagging presents additional difficulties because of the time delay between when a user tags a particular portion of a real-time media and when that particular portion actually occurred. For example, up to 60 seconds or more may pass from the beginning of a joke to the end of the joke, plus the time when the user laughs. After this time, the user thinks to tag the joke as “funny” and the tag is entered at a far later time than the actual joke. Because the event is live, the “funny” tag may inappropriately attach to an unintended subsequent portion. The real-time nature of live events and the lag time or inaccuracy associated with some tagging actions both cause problems in connecting the tags with the actual intended portion of the media event. Known solutions in the art do not adequately address real-time tagging and how to solve the problems presented due to the nature of tagging live media events.

One solution to this problem in the past is to apply tags only to recorded content because a user can pause, rewind, and more precisely tag recorded content. However, some events, such as a small business meeting or a conference call are not always recorded and the spontaneity of the tagging experience is lost.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for classifying a live media tag into a type. The method includes receiving a group of tags generated in real time and associated with at least a portion of a live media event, identifying a tag type for at least one tag in the group of tags, and classifying the at least one tag as the tag type.

Tags can include text, images, audio, video, a number rating, a selection from a list of options, a hyperlink, and any combination thereof. Users can enter tags via any of a number of services, such as text messaging, Twitter, Facebook, a comment submitted via an HTML form, a dictated voice message, and so forth. The tags described herein apply to media streams in real time. For example, a stream of still images shown, such as from a web-enabled camera, can be tagged with event names, names of people, dates, times, and so forth.

A tag applied to an event in real time without a type description does not adequately indicate the types of content that arise in an interaction. In a conference, many things can happen: people ask questions, a conference moderator identifies a follow-up action, speakers take turns, topics of discussion change, participants discuss bullet points on an agenda, and speakers join or leave the conference. The fluid and potentially unpredictable nature of a live event can cause many problems with tagging. For example, a person may want to tag the previous question in a meeting, but since the previous question was 45 seconds ago, entering a tag at the current time may not connect that tag to the appropriate content. The approaches disclosed herein allow a user to tag an event in real time easily and accurately.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a block diagram of an exemplary communications architecture for supporting tagging during a media event;

FIG. 3 illustrates an example tagging system configuration;

FIG. 4 illustrates an example representation of a real-time media event overlaid with tags and tag types;

FIG. 5 illustrates an example user interface for entering a tag and a tag type;

FIG. 6 illustrates an example of adjusting a tag based on a tag type;

FIG. 7 illustrates an exemplary visualization of a media event based on tags and tag types; and

FIG. 8 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure addresses at least the issues raised above by providing additional data with a tag that can identify, for example, the tag type, context, or many other categories of metadata to connect that tag to live content. As a user participates in a media event (such as a radio show, television show, conference call, video conference, image stream, live sporting event, and so forth), the user and other users tag the media event. The tagging system, which can be integrated with the media event presentation system or can be entirely separate, receives the tags and an optional tag type. Users can generate a tag type or select a tag type from a list of predefined or suggested types. The system can also generate tag types based on the tag context, content, author, timing, content of the associated media event, and so forth.

Further, applications can selectively act on the tags based on their tag type. For example, users tag a planning meeting with multiple tags, some of which are of the type “follow up action”. The system can trigger a summary application to analyze and prepare tags of type “follow up action” as an action item list for the participants of the meeting and email the action item list to the participants. Other use of tag types include visualizations showing how much each person spoke during a meeting based on tags having a type showing speaker turn.

Further, the tags can incorporate metadata describing who created the tag, when the tag was created, what actions the user took to tag, dynamically created user metadata input, and so forth. An example live event includes 10 minutes of Mary speaking, followed by 3 minutes of Joe speaking A user tagging the event 1 minute into Joe's portion recalls something from Mary's portion and wants to tag it. The system can present a dynamically changing set of easily selectable options when the user indicates that she wants to tag something. The system, for example, can detect likely candidate tagging points and maintain a list of recent candidate tagging points. The system can use this list as possible suggestions to users who want to tag prior portions of the live event. Thus, the user can associate the tag “great idea!” with a tag type such as “Mary” and “pension proposal”.

In another aspect, a tagging server automatically generates tag types and attaches the tag types to tags. Thus, the user only needs to tag the event and the system generates tag types automatically as the media event moves from topic to topic or person to person and connects these tag types to incoming tags. For example, the system automatically determines that Mary is speaking The system can make this determination via voice recognition, access to a schedule, or other manual user input. The system can generate confidence scores from each of these sources to guess a most likely speaker. Further, as users submit tags, the tag content can indicate or imply the speaker as Mary. This aspect is based on an assumption that the tags are provided roughly at the same time as the portion of the live event intended to tag. In another case, the system receives and analyzes the tag data to adjust or create the tag type. If Mary just finished and Joe starts his portion of the presentation and a user tags “Mary gave a great talk”, the system can analyze that tag and identify that the tag does not relate to Joe, but Mary based on the content of the tag. The system can then adjust the tag type and/or metadata accordingly. The system can perform more rigorous analysis that simply keyword or name matching. For example, if, 2 minutes into Joe's talk, the user tags “that was a great talk”, the system can analyze the past tense verb “was” and deduce that the tag applies to Mary and not the current talk by Joe.

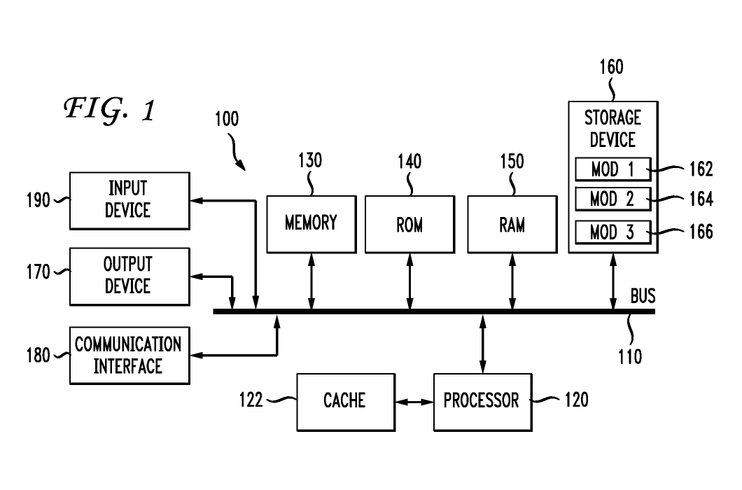

A system, method and non-transitory computer-readable media are disclosed which address multiple variations of classifying user-generated and/or system-generated tags into tag types. A brief introductory description of a basic general purpose system or computing device as shown in FIG. 1 which can be employed to practice the concepts is disclosed herein. A more detailed description of the various tagging infrastructure elements follows. These and other variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

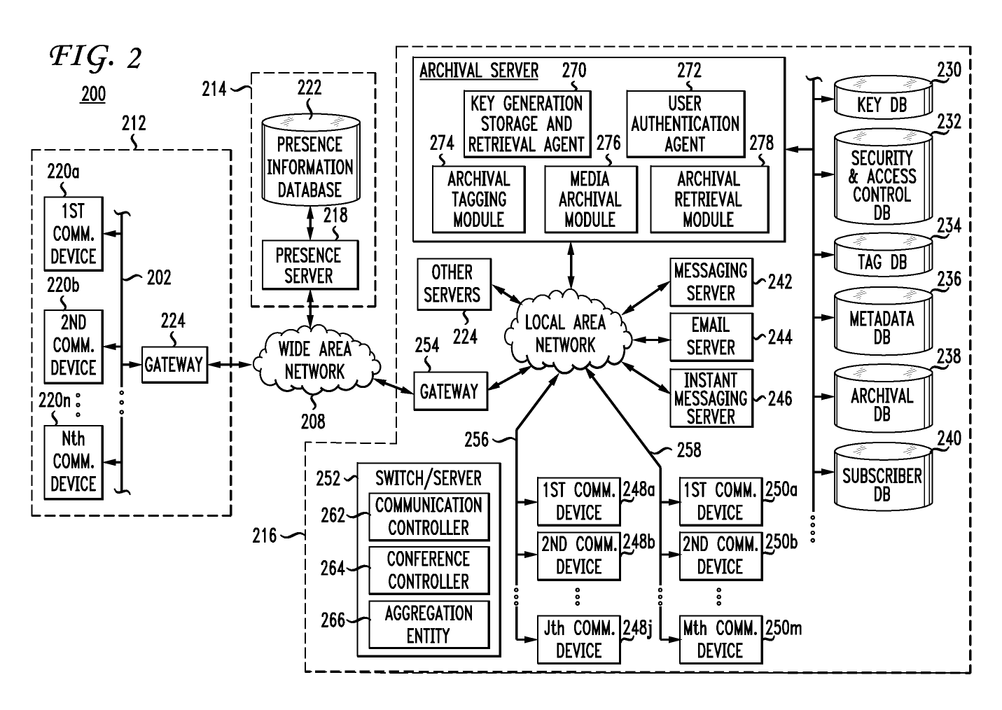

The disclosure now turns to an exemplary environment supporting tagging for media events as illustrated in FIG. 2. Some tagging implementations rely on network infrastructure, but other tagging implementations encompass only a single device without a network. The communications architecture 200 described below as including specific number and types of components is an illustrative example only. The principles disclosed herein can be implemented using other architectures, including architectures with more or less components than shown in FIG. 2.

As shown in FIG. 2, first and second enterprise Local Area Networks (LANs) 202 and 204 and presence service 214 are interconnected by one or more Wide Area private and/or public Network(s) (WANs) 208. The first and second LANs 202 and 204 correspond, respectively to first and second enterprise networks 212 and 216.

As used herein, the term “enterprise network” refers to a communications network associated and/or controlled by an entity. For example, enterprise networks 212 and 216 can be a communications network managed and operated by a telephony network operator, a cable network operator, a satellite communications network operator, or a broadband network operator, to name a few.

The first enterprise network 212 includes communication devices 220a , 220b . . . 220n (collectively “220”) and a gateway 224 interconnected by the LAN 202. The first enterprise network 212 may include other components depending on the application, such as a switch and/or server (not shown) to control, route, and configure incoming and outgoing contacts.

The second enterprise network 216 includes a gateway 224, an archival server 228 maintaining and accessing a key database 230, a security and access control database 232, a tag database 234, a metadata database 236, an archival database 238, and a subscriber database 240, a messaging server 242, an email server 244, an instant messaging server 246, communication devices 248a, 248b, . . . , 248j (collectively “248”), communication devices 250a, 250b, . . . , 250m (collectively “250”), a switch/server 252, and other servers 254. The two enterprise networks may constitute communications networks of two different enterprises or different portions a network of single enterprise.

A presence service 214, which can be operated by the enterprise associated with one of networks 204 and 208, includes a presence server 218 and associated presence information database 222. The presence server 218 and presence information database 222 collectively track the presence and/or availability of subscribers and provide, to requesting communication devices, current presence information respecting selected enterprise subscribers.

As used herein, a “subscriber” refers to a person who is serviced by, registered or subscribed with, or otherwise affiliated with an enterprise network, and “presence information” refers to any information associated with a network node and/or endpoint device, such as a communication device, that is in turn associated with a person or identity. Examples of presence information include registration information, information regarding the accessibility of the endpoint device, the endpoint's telephone number or address (in the case of telephony devices), the endpoint's network identifier or address, the recency of use of the endpoint device by the person, recency of authentication by the person to a network component, the geographic location of the endpoint device, the type of media, format language, session and communications capabilities of the currently available communications devices, the preferences of the person (e.g., contact mode preferences or profiles such as the communication device to be contacted for specific types of contacts or under specified factual scenarios, contact time preferences, impermissible contact types and/or subjects such as subjects about which the person does not wish to be contacted, and permissible contact type and/or subjects such as subjects about which the person does wish to be contacted. Presence information can be user configurable, i.e., the user can configure the number and type of communications and message devices with which they can be accessed and to define different profiles that define the communications and messaging options presented to incoming contactors in specified factual situations. By identifying predefined facts, the system can retrieve and follow the appropriate profile.

The WAN(s) can be any distributed network, such as packet-switched or circuit-switched networks, to name a few. In one configuration, the WANs 208 include a circuit-switched network, such as the Public Switch Telephone Network or PSTN, and a packet-switched network, such as the Internet. In another configuration, WAN 208 includes only one or more packet-switched networks, such as the Internet.

The gateways 224 can be any suitable device for controlling ingress to and egress from the corresponding LAN. The gateways are positioned logically between the other components in the corresponding enterprises and the WAN 208 to process communications passing between the appropriate switch/server and the second network. The gateway 224 typically includes an electronic repeater functionality that intercepts and steers electrical signals from the WAN to the corresponding LAN and vice versa and provides code and protocol conversion. Additionally, the gateway can perform various security functions, such as network address translation, and set up and use secure tunnels to provide virtual private network capabilities. In some protocols, the gateway bridges conferences to other networks, communications protocols, and multimedia formats.

In one configuration, the communication devices 220, 248, and 250 can be packet-switched stations or communication devices, such as IP hardphones, IP softphones, Personal Digital Assistants or PDAs, Personal Computers or PCs, laptops, packet-based video phones and conferencing units, packet-based voice messaging and response units, peer-to-peer based communication devices, and packet-based traditional computer telephony adjuncts.

In some configurations, at least some of communications devices 220, 248, and 250 can be circuit-switched and/or time-division multiplexing (TDM) devices. As will be appreciated, these circuit-switched communications devices are normally plugged into a Tip ring interface that causes electronic signals from the circuit-switched communications devices to be placed onto a TDM bus (not shown). Each of the circuit-switched communications devices corresponds to one of a set of internal (Direct-Inward-Dial) extensions on its controlling switch/server. The controlling switch/server can direct incoming contacts to and receive outgoing contacts from these extensions in a conventional manner. The circuit-switched communications devices can include, for example, wired and wireless telephones, PDAs, video phones and conferencing units, voice messaging and response units, and traditional computer telephony adjuncts. Although not shown, the first enterprise network 212 can also include circuit-switched or TDM communication devices, depending on the application.

Although the communication devices 220, 248, and 250 are shown in FIG. 2 as being internal to the enterprises 212 and 216, these enterprises can further be in communication with external communication devices of subscribers and nonsubscribers. An “external” communication device is not controlled by an enterprise switch/server (e.g., does not have an extension serviced by the switch/server) while an “internal” device is controlled by an enterprise switch/server.

The communication devices in the first and second enterprise networks 212 and 216 can natively support streaming IP media to two or more consumers of the stream. The devices can be locally controlled in the device (e.g., point-to-point) or by the gateway 224 or remotely controlled by the communication controller 262 in the switch/server 252. When the communication devices are locally controlled, the local communication controller should support receiving instructions from other communication controllers specifying that the media stream should be sent to a specific address for archival. If no other communication controller is involved, the local communication controller should support sending the media stream to an archival address.

The archival server 228 maintains and accesses the various associated databases. This functionality and the contents of the various databases are discussed in more detail below.

The messaging server 242, email server 244, and instant messaging server 246 are application servers providing specific services to enterprise subscribers. As will be appreciated, the messaging server 242 maintains voicemail data structures for each subscriber, permitting the subscriber to receive voice messages from contactors; the email server 244 provides electronic mail functionality to subscribers; and the instant messaging server 246 provides instant messaging functionality to subscribers.

The switch/server 252 directs communications, such as incoming Voice over IP or VoIP and telephone calls, in the enterprise network. The terms “switch”, “server”, and “switch and/or server” as used herein should be understood to include a PBX, an ACD, an enterprise switch, an enterprise server, or other type of telecommunications system switch or server, as well as other types of processor-based communication control devices such as media servers, computers, adjuncts, etc. The switch/media server can be any architecture for directing contacts to one or more communication devices.

The switch/server 252 can be a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide automatic contact-distribution functionality. Exemplary control programs include a communication controller 262 to direct, control, and configure incoming and outgoing contacts, a conference controller 264 to set up and configure multi-party conference calls, and an aggregation entity 266 to provide to the archival server 228 plural media streams from multiple endpoints involved in a common session. The switch/server can include a network interface card to provide services to the associated internal enterprise communication devices.

The switch/server 252 can be connected via a group of trunks (not shown) (which may be for example Primary Rate Interface, Basic Rate Interface, Internet Protocol, H.323 and SIP trunks) to the WAN 208 and via link(s) 256 and 258, respectively, to communications devices 248 and communications devices 250, respectively.

Other servers 254 can include a variety of servers, depending on the application. For example, other servers 254 can include proxy servers that perform name resolution under the Session Initiation Protocol or SIP or the H.323 protocol, a domain name server that acts as a Domain Naming System or DNS resolver, a TFTP server 334 that effects file transfers, such as executable images and configuration information, to routers, switches, communication devices, and other components, a fax server, ENUM server for resolving address resolution, and mobility server handling network handover, and multi-network domain handling.

The systems and methods of the present disclosure do not require any particular type of information transport medium or protocol between switch/server and stations and/or between the first and second switches/servers. That is, the systems and methods described herein can be implemented with any desired type of transport medium as well as combinations of different types of transport media.

Although the present disclosure may be described at times with reference to a client-server architecture, it is to be understood that the present disclosure also applies to other network architectures. For example, the present disclosure applies to peer-to-peer networks, such as those envisioned by the Session Initiation Protocol (SIP). In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Moreover, the present disclosure does not require a specific Internet Protocol Telephony (IPT) protocol. Additionally, the principles disclosed herein do not require the presence of packet- or circuit-switched networks.

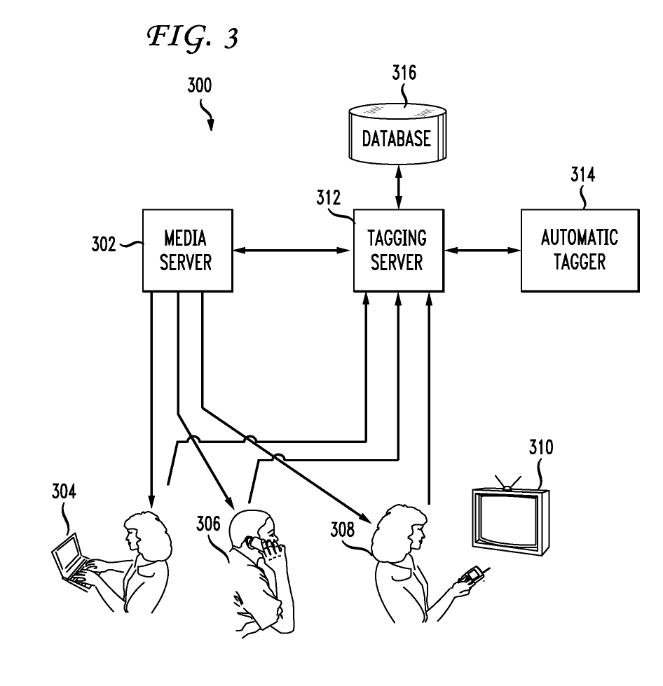

Having disclosed some basic system components and configurations, the disclosure now turns to a discussion of an example tagging system configuration 300 as shown in FIG. 3. In this configuration, a media server 302 serves a media event to multiple users 304, 306, 308. The media event can be a live event that does not require a media server 302 for live participants, such as an audience in a stadium watching a sporting event or a live audience of a variety show or a game show. In one variation, a live studio audience provides tags that are combined with tags and tag types from broadcast viewers at a later time. The media server 302 can serve the media event to user devices such as television, telephone, smartphone, computer, digital video recorders, and so forth. The media server 302 can deliver the media event live, in real time, or substantially in real time via any suitable media delivery mechanism, such as analog or digital radio broadcast, IP (such as unicast, multicast, anycast, broadcast, or geocast), and cable or satellite transmission.

As users 304, 306, 308 participate in, view, or listen to the media event, the users provide tags and/or tag types describing the media event. The number of users can be as few as one and can range to hundreds, thousands, or millions, depending on the media event and its audience. For example, if the media event is a real-time broadcast of a sitcom episode, millions of viewers may be watching (participating) simultaneously. Viewers can tag the sitcom with tags such as “funny joke”, “she's going to be really angry”, or “theme music”. Viewers can provide tags in the form of text, speech, video, images, emoticons, sounds, feelings, gestures, instructions, links, files, indications of yes, no, or maybe, symbols, characters, other forms, and combinations thereof. Further, tags can be unrelated or not directly related to specific content of the media event as presented. For example, users or automatic taggers can tag the media event when something happens offstage, when a breaking news story of an event located appears on cnn.com, when someone off camera does something interesting, when a part of the media event reminds the user of a childhood memory, or when a part of the media event is like another media event.

The system delivers these tags to a tagging server 312 and stored in a database 316. The tags can describe events, persons, objects, dialog, music, or any other aspect of the media event. The tags can further be objective or subjective based on the user's views, feelings, opinions, and reactions to the media event. In one aspect, the media server 302 delivers the media event to one user device 310, such as a television, and the user tags the media event with another device, such as a remote control, smartphone, or a computing tablet. In another aspect, the user tags the media event using the same device that is receiving the media event, such as a personal computer. The tagging server 312 can also store tag metadata and tag types in the database 316. Tag metadata describes additional information about the tag, such as which user provided the tag, what portion of the media event the tag applies to, when the tag was created (if the tag is not created during a real time media event), a tag type, and so forth.

The media server 302 can transmit all or part of the media event to an automatic tagger 314. The automatic tagger 314 is a computing device or other system that automatically monitors the media event, human taggers, or other related information sources for particular trigger conditions. The automatic tagger 314 can generate tags and modify existing tags and/or tag types based on some attribute such as a particular speaker, clapping, or an advertisement, or based on segments where X percent of user tags contained a keyword, or X number of tags had a high rating, and so forth. When the automatic tagger 314 finds the trigger conditions, the automatic tagger 314 generates a corresponding tag and sends it to the tagging server 312. The trigger conditions can be simple or complex. Some example simple trigger conditions include the beginning of a media event, the ending of a media event, parsing of subtitles to identify key words, and so forth. Some example complex trigger conditions include detecting speaker changes, detecting scene changes, detecting commercials, detecting a goal in a soccer game, identifying a song playing in the background, and so forth.

In one variation, the automatic tagger 314 further annotates or otherwise enhances human-generated tags. For example, if a user enters a tag having a typographical error, the automatic tagger 314 can correct the typographical error. In another example, if the user is in view of a camera, the automatic tagger can perform facial recognition of a user at the time he or she is entering a tag. The automatic tagger 314 can infer an emotional state of the user at that time based on the facial expressions the user is making For example, if the user grimaces as he enters a tag, the automatic tagger 314 can include “disgusted emotional state” metadata to the entered tag. If the user is giggling as she enters a tag, the automatic tagger can include “humorous” metadata to the entered tag as well as a confidence score in the metadata. For example, if the user produces a modest giggle, the confidence score can be low, whereas if the user produces a loud, prolonged guffaw, the confidence score can be high. The automatic tagger 314 can also analyze body language, body position, eye orientation, speech uttered to other users while entering a tag, and so forth. In this aspect, the automatic tagger 314 can be a distributed network of sensors that detect source information about users entering tags and update the entered tags and/or their metadata accordingly.

The automatic tagger 314 can process one or more media events. The automatic tagger 314 can also provide tag metadata to the tagging server 312. The tagging server 312, the media server 302, and/or the automatic tagger 314 can be wholly or partially integrated or can be entirely separate systems.

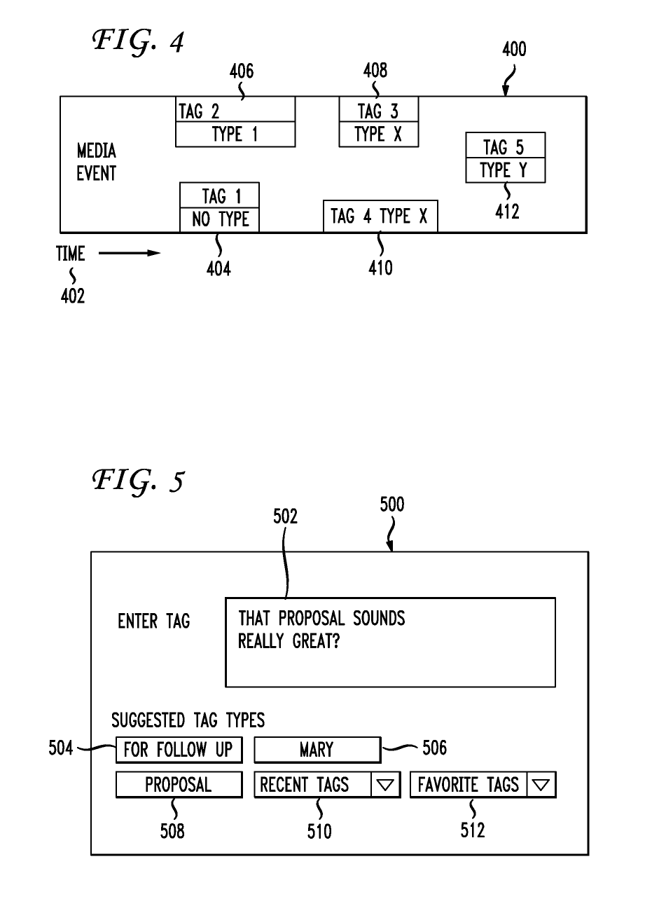

The disclosure now turns to a discussion of the example representation of a real-time media event 400 overlaid with tags and tag types as shown in FIG. 4. The media event 400 progresses through time 402 from left to right. Individual users or an automated tagging system can provide the tags. As the media event 400 progresses through time 402, multiple tags and tag types are submitted in real time. For example, a user submits Tag 1 404 with no tag type. A user and/or automated system can assign Tag 1 404 a type immediately after the tag was submitted and/or at a later time. An automated system submits Tag 2 406 with a type. Note that Tag 2 406 covers a longer portion of the media event 400 than Tag 1 404. Tags and their associated tag types can cover any duration from a single point in time to the entire media event 400 and can even span multiple media events. The tag type can indicate, for example, a particular speaker's turn, a participant joining or leaving the event, a question, a follow-up action, a goal (in a game), an advertisement (in a telecast), links (to presentations, videos, photos, documents etc.), notes or other comments, a tag media type (i.e. text, image, audio, video), and so forth. In one embodiment, the tag type is a specific piece of tag metadata. In another embodiment, the tag type is included as part of the tag itself. The tag type can be a prefix or suffix appended to the tag itself. For example, the system can append the type “ACTION ITEM” to a tag “review meeting minutes” to yield “<ACTION ITEM> review meeting minutes” or “review meeting minutes ˜ACTION ITEM”. The tags and its associated tag types can be stored in a single file or database or in separate files or databases.

Different entities can submit multiple tags 408, 410 at substantially the same time. In this case, Tag 3 408 and Tag 4 410 are both of type x. The system can analyze tags with similar or same types submitted within a range of time and merge or combine the tags based on the type and/or tag similarity. Thus, Tag 5 412, even if it is submitted within a close temporal proximity to Tag 3 408 and Tag 4 410, would not be merged or combined because it is of a different type. Merged or combined tags can include an indication of why the system combined the tags and an indication of increased tag strength based on the number of the tags combined. Thus, a merged tag from 50 tags of a common type has a higher strength or ranking than a merged tag from only 3 tags of a common type.

As one user participates in or views the media event, she can also see a live stream of tags from other users. She can ‘retag’ an existing tag to increase its frequency. The system can duplicate the retagged tag and add a type of ‘retag’ or other suitable type. The retagged tag can also include a link to the original tag in order to trace back to the original source tag and its creator.

FIG. 5 illustrates an example user interface for entering a tag and a tag type. The user can view the media event and enter tags on a single device or via a group of devices. For example, the user can participate in a teleconference on a personal computer and enter tags via the same personal computer. Alternatively, the user can enter tags via a separate smartphone. In the exemplary interface 500, the user enters a tag via a text field 502. However, the user can enter multimedia tags via a microphone and/or camera. The user can paste an image as a tag. The tag can include multiple media formats, such as text and an image. The tag entry device displaying the interface 500 can guide, at least in part, how users enter tags and which kinds of tags users can enter. As the tag is being entered or after the tag is entered, the system can determine a set of predicted tag types from the context and/or content of the tag. In this example, the system presents multiple tag type options 504, 506, 508. In addition to these user-selected tag types, the system can assign certain other types, such as a tag media format type. In this case, the tag media format type is “text”. Alternatively, the system can present a pull-down list or other list of recently used tags 510 or favorite tags 512. The list of favorite tags 512 can be generated based on a user tag history or on a tag history of all participants in the media event. After the user enters the tag text and/or other tag content and optionally selects one or more type for the tag, the user can submit, post, commit, and/or share the tag. Multiple users can generate tags for the same media event using different device and different interfaces. For example, participants can tag via SMS, Twitter, Facebook, email, telephone call, instant messaging, web portal, and so forth.

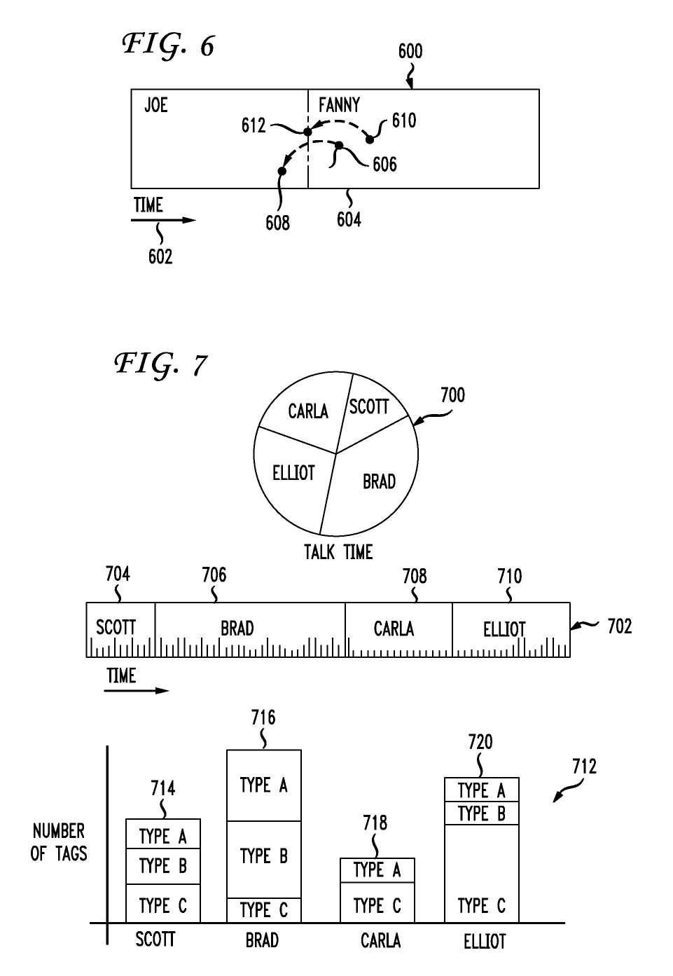

FIG. 6 illustrates an example of adjusting a tag based on a tag type. In this example, a media event 600, such as a news broadcast, includes a segment 602 from newscaster Joe and a segment 604 from newscaster Fanny. As users generate tags in real time based on the media event 600, the users sometimes submit tags later than the portion to which the tag is directed. For example, at the end of Joe's segment, Joe presents contact information for the local farmers market, but the user generates the tag “farmer market contact”, intended for Joe's segment, at point 606 in the beginning of Fanny's segment 604. The tagging server can analyze the text content of the tag “farmer market contact”, recognize that the tag more appropriately belongs to the end of Joe's segment 602, and shift, move, or reassign the tag to the appropriate place 608 within Joe's segment 602. Likewise, if the user submits a tag at point 610 indicating a newscaster transition, the system can realign that tag with the actual transition 612. The system can adjust user tags in other ways, such as correcting misspelled names, moving the tags forward in time, changing the beginning/ending point of a tag, and adding or removing tag types.

In one variation, the system notifies the user that the tag has been changed. The notification can be a popup, a text message, an email, a spoken audio message or other suitable notification mechanism. In another variation, the system proposes to the user a suggested change or changes to a tag and only makes the changes approved by the user. The system can perform this suggestion aspect after the user submits the tag or on the fly while the user is creating the tag.

FIG. 7 illustrates an exemplary visualization of a media event based on tags and tag types. In this example, a media event 702 is divided into four segments, one for each speaker in the media event. The media event 702 shows a series of vertical lines that represent a flow of submitted tags during that time portion of the media event. The four segments include a first segment 704 for Scott, a second segment 706 for Brad, a third segment 708 for Carla, and a fourth segment 710 for Elliot. The system can present visualizations for these four segments based on user submitted and/or system generated tags and tag types. For example, the system can display a chart 700, based on tags associated with each speaker, showing the relative amounts of time each speaker participated in the media event. Another chart 712 represents, for each speaker, a total number of submitted tags by type associated with each speaker 714, 716, 718, 720. In any of these representations, a viewer can drill down into any individual part of any of the chart for more information. Drilling down can reveal information such as tag contents, tag types, tag submitters, tag metadata, an associated portion of the media event, related tags, and so forth. The system prepares such summaries based at least in part on groups of tags and their respective tag types. While displaying the summary to the user, the system can also simultaneously play back the at least part of the live media event and at least part of the group of tags and their respective tag types.

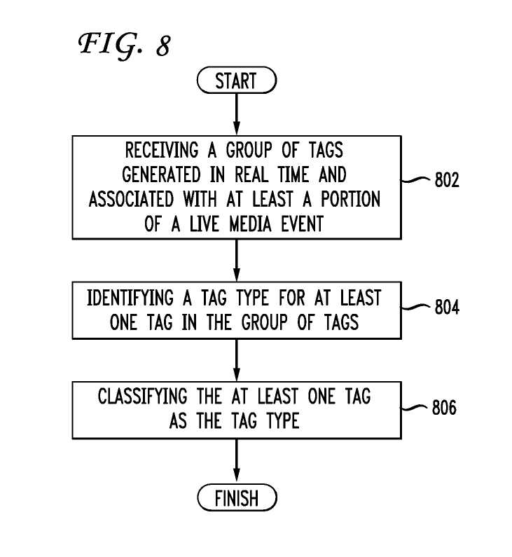

Having disclosed some basic system components, the disclosure now turns to the exemplary method embodiment shown in FIG. 8. This approach allows for multiple different types of tags to attach to various parts of a media event to provide additional information, accuracy, and flexibility in tagging. For example, a tag type can be a question, follow-up action, link, note, presentation etc. The tag type allows applications to treat tags differently based on type. This concept associates live tags to a variety of tag types, thereby enabling more precision and flexibility when tagging a media event such that more information about the tagging exists and can be processed other than the tag itself. For the sake of clarity, the method is discussed in terms of an exemplary system 100 such as is shown in FIG. 1 configured to practice the method.

First, the system 100 receives a group of tags generated in real time and associated with at least a portion of a live media event (802). One or more users in multiple locations using multiple tagging platforms and infrastructures can generate tags for the live media event. For example, a first user can tag via a smartphone app while watching a boxing match at home on pay per view. A second user can tag via text messaging while receiving a live text-based, blow-by-blow summary of the boxing match. A third user can tag via a tagging device integrated into his seat as he views the boxing match live in the arena. A central tagging server can receive, process, and translate the tags and types submitted via different tagging infrastructures.

The system 100 identifies a tag type for at least one tag in the group of tags (804). The tag type can be, for example, a system-defined type, a user-entered type, a category, a media category, and/or a text label. The system 100 can further send to a user a list of suggested tag types for the at least one tag in the group of tags, receive from the user a selection of a suggested tag type from the list of suggested tag types, and identify the tag type as the suggested tag type. Further, the system 100 can identify the tag type based on tag content, tag context, tag metadata, an associated position in the media content, and/or similarity of the at least one tag to other tags. A tag type likelihood score or confidence score can be assigned to the tag as an indication of how certain the system is in the tag type selection. A user can then confirm, reject, or modify tag types with a lower confidence score.

The system 100 classifies the at least one tag as the tag type (806). A tag can be classified as more than one type. For example, in the boxing match example above, a tag “left jab to the jaw” can have multiple types such as “second round”, “attack”, “defending champion”, and “Las Vegas”. The system can identify and classify based on additional user input. For example, the user can submit a tag, then later return to the tag and assign a type. A tag can have several types or a single type with multiple facets. The system can include different types of tag types, such as primitive types and more complex types. Multiple primitive tag types can be combined into a more complex tag type. Some tag types can refine other tag types to allow for classification or faceted search of tags and/or tag types. For example, a user can assign one tag a type of “editorial”. A second user refines that tag type with another tag type “positive”. A third user can refine one or both of those tag types with the tag type “funny”. In one aspect, multiple tags are arranged in a hierarchy. The system can infer tag and tag type relationships from the hierarchy structure and the placement of tags within the hierarchy. In the example above, the tag type “editorial” can reside at a top level of the hierarchy. The tag type “positive” resides in the hierarchy below “editorial”, indicating that “positive” modifies the type “editorial” and not necessarily the entire tag. The tag hierarchy can be a tree structure or can simply be a group of levels, such as high-level content descriptions, general feelings and reactions to the content, criticisms of the content grammar, and so forth.

This example of multiple users demonstrates another aspect of tagging and types of tags. A tag type can be combined with a user type, such as the context information of the originator of the tag or of the tag type. Some example tags include “question from student” or “question from lecturer”. One user, multiple users, and/or automated approaches can generate multiple tag types for a given tag.

The tag type can trigger an automated action based on the tag type. For example, when a certain tag type, such as “attack” appears in the boxing match, the system can store a snapshot of the boxing match. The system can extract and combine 10 second portions surrounding each cluster of at least 200 tags having the type “attack” in order to prepare a video summary of all the most popular portions of the boxing match. The tag type or tag type threshold can trigger actions inside the system and/or outside the system.

The system provides users with a way to filter tags based on type. The system receives from a user a tag type criterion, filters the group of tags based on their respective tag types, and outputs the filtered group of tags. In this way, users can easily eliminate unwanted types, classes, or categories of tags, such as “offensive language” or all tags from a specific tagger or group of taggers. Alternatively, users can easily focus on a specific subset of tags. For example, a user can search a tag corpus by keyword limited to a specific tag type(s).

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein are applicable to virtually any media device that accepts user input. Those skilled in the art will readily recognize various modifications and changes that may be made to the principles described herein without following the example embodiments and applications illustrated and described herein, and without departing from the spirit and scope of the disclosure.

We claim:

1. A method of classifying a live media tag into a type, the method comprising:
receiving a group of tags generated in real time and associated with at least a portion of a live media event;
identifying a tag type for at least one tag in the group of tags; and
classifying the at least one tag as the tag type.

2. The method of claim 1, wherein the tag type is at least one of a system-defined type, a user-entered type, a category, a media category, and a text label.

3. The method of claim 1, wherein the group of tags is generated in real time by a plurality of users.

4. The method of claim 3, wherein the group of tags is generated via a plurality of tagging platforms.

5. The method of claim 1, wherein identifying and classifying are performed based on additional user input.

6. The method of claim 1, wherein identifying the tag type further comprises:
sending to a user a list of suggested tag types for the at least one tag in the group of tags;
receiving from the user a selection of a suggested tag type from the list of suggested tag types; and
identifying the tag type as the suggested tag type.

7. The method of claim 1, wherein identifying the tag type is based on at least one of tag content, tag context, tag metadata, an associated position in the media content, and similarity of the at least one tag to other tags.

8. The method of claim 7, wherein identifying the tag type is further based on a tag type likelihood.

9. The method of claim 1, further comprising:
receiving a tag type criterion;
filtering the group of tags based on their respective tag types to yield a filtered group of tags; and
outputting the filtered group of tags.

10. The method of claim 1, further comprising:
preparing a summary of at least part of the live media event based on at least part of the group of tags and their respective tag types; and
displaying the summary to a user.

11. The method of claim 10, wherein displaying the summary to the user further comprises simultaneously playing back the at least part of the live media event and the at least part of the group of tags and their respective tag types.

12. The method of claim 1, further comprising:
adjusting how the at least one tag is associated with the live media event based on the tag type.

13. The method of claim 12, wherein adjusting how the at least one tag is associated with the live media event comprises at least one of moving a start point of the at least one tag, moving an end point of the at least one tag, changing a duration of the at least one tag, and updating at least part of metadata associated with the at least one tag.

14. The method of claim 1, further comprising classifying the at least one tag as more than one tag type.

15. The method of claim 1, wherein classifying the at least one tag as the tag type triggers an automated action based on the tag type.

16. A system for classifying a live media tag into a type, the system comprising:
a processor;
a first module configured to control the processor to receive, from a user, a tag associated with a live media event;
a second module configured to control the processor to transmit the tag to a tag server;
a third module configured to control the processor to receive from the tag server at least one suggested tag type for the tag;
a fourth module configured to control the processor to display the at least one suggested tag type to the user.

17. The system of claim 16, further comprising:
a fifth module configured to control the processor to receive, from the user, a selected tag type from the at least one suggested tag type; and
a sixth module configured to assign the selected tag type to the tag.

18. The system of claim 16,

19. A non-transitory computer-readable storage medium storing instructions which, when executed by a computing device, cause the computing device to classify a live media tag under a tag type, the instructions comprising:
receiving a group of tags generated in real time and associated with at least a portion of a live media event;
identifying a tag type for at least one tag in the group of tags; and
classifying the at least one tag as the tag type.

20. The non-transitory computer-readable storage medium of claim 19, the instructions further comprising:
preparing a summary of at least part of the live media event based on at least part of the group of tags and their respective tag types; and
displaying the summary to a user.
